(19) United States
(12) Patent Application Publication
(10) Pub. No.: US 2025/0168526 A1
(43) Pub. Date: May 22, 2025

(54) OPTICAL BLACK PIXEL REFERENCE TO REMOVE IMAGE BIAS NOISE FOR WESTERN BLOT IMAGING

(71) Applicant: Bio-Rad Laboratories, Inc., Hercules, CA (US)

(72) Inventors: Evan Paul Thrush, San Anseimo, CA (US); Kevin Alan McDonald, Novato, CA (US); Keith V. Kotchou, Walnut Creek, CA (US)

(21) Appl. No.: 18/943,873

(22) Filed: Nov. 11, 2024

Related U.S. Application Data
(60) Provisional application No. 63/599,955, filed on Nov. 16, 2023.

(51) Int. Cl. H04N 25/633; H04N 25/46

(52) U.S. Cl. CPC H04N 25/633; H04N 25/46

(57) ABSTRACT

An imaging system dynamically computes an offset for an image based on an active region and a reference region of an image sensor used to generate the image. The imaging system applies the offset to pixels of the image. The imaging system further processes the image by performing flat-fielding, binning, or both.

### CROSS-REFERENCE TO RELATED APPLICATIONS

This application claims the benefit of U.S. Provisional Application No. 63/599,955, filed on Nov. 16, 2023, which is incorporated by reference.

### BACKGROUND

### Field of the Art

This present disclosure generally relates to image processing and particularly relates to determining image sensor offsets.

### Problem

Imaging systems use image sensors to detect light in a field of view. For example, an imaging system may use an image sensor to capture images of biological samples, such as proteins in a blood or tissue sample produced as part of a Western blotting technique. Imaging systems often process images using flat-field correction. Flat-field correction, or “flat-fielding,” is an image processing technique used to correct pixel-to-pixel variations in an image that are caused by the image sensor or the imaging system, rather than by the phenomenon being detected. Variations may be caused by scratches or artifacts on the lens of the image sensor, by gains or dark currents in the image sensor, or by the shape of the lens itself.

Flat fielding relies on the assumption that an image sensor should detect a uniform output for a uniform input, meaning that any variations in the output (e.g., variations in pixel values) resulting from a controlled, known input (e.g., the response of the sensor in complete darkness) require correction. To perform flat-fielding, an imaging system computes an offset of an image sensor, the offset representing background or baseline response of the pixels of the image sensor experience in response to the controlled input. In other words, the offset indicates what value reported by pixels of the image sensor corresponds to a “true zero.” The imaging system applies the offset to captured images to correct the values of the pixels.

However, image sensors do not have consistent offsets over time. An image sensor may report an offset of 100 for a first image and an offset of 99 or 101 for an identical second image. Even small initial errors in offset can be amplified by downstream image processing techniques. There is therefore a need for more accurate determinations of offset for flat-fielding.

### BRIEF DESCRIPTION OF THE DRAWINGS

FIG. 1 is a high-level block diagram of a system environment suitable for image processing, according to one embodiment.

FIG. 2 is a block diagram of the imaging system for processing images of FIG. 1, according to one embodiment.

FIG. 3 illustrates an active region and reference region of an image sensor, according to one embodiment.

FIG. 4 is a flowchart of a method for processing an image using flat-fielding and binning techniques, according to one embodiment.

FIG. 5 illustrates a computing system that may be used in the system environment of FIG. 1, according to one embodiment.

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### DETAILED DESCRIPTION

### Overview

In various embodiments, imaging systems process images using flat-field correction and binning. Flat-field correction, or “flat-fielding,” is an image processing or calibration technique used to improve the consistency of results obtained by measuring a sample regardless of where it is placed within the field of view of an image sensor in an imaging system. Flat-fielding corrects for pixel-to-pixel variation caused by different gains or dark currents in the image sensor. Flat-fielding may also correct for imaging lens vignetting, illumination non-uniformity, or application-specific illumination, for example in applications involving fluorescence. Flat-fielding relies on the assumption that an image sensor should detect a uniform output for a uniform input, meaning that any variations in the output, such as variations in pixel values, require correction. Binning is an image processing technique used to reduce the resolution of an image and increase system sensitivity. Binning pixels improves a signal to noise ratio, amplifying signals and reducing noise.

Both flat-field correction and binning involve adjusting the values of pixels. With flat-fielding, pixel values are adjusted to correct for variations caused by the image sensor. With binning, pixel values are combined with values of adjacent pixels. As such, proper application of both techniques relies on accurate pixel values. When flat-fielding a particular pixel, the offset error (i.e., the difference between the determined offset that is used to adjust the pixel value and the true offset) is also multiplied by whatever factor the particular pixel value is multiplied by for the flat-field correction. Similarly, binning combines the values of pixels in an image, but also combines the corresponding offset error of each pixel. For example, applying binning to a 16 by 16 array of pixels amplifies the offset error by 256 times (one instance of the offset error per pixel included in the bin). Thus, the errors resulting from flat-field correction to an image and binning can be significantly reduced by determining more accurate offsets for the image sensor than were possible with prior techniques, particular in use cases where binning is performed on pixel data.

In various embodiments, an imaging system computes an offset based on an active region and a reference region of an image sensor. The imaging system receives an image from an image sensor, the image including a set of pixels. The imaging system identifies an active region and a reference region of the image sensor and computes an offset by averaging values of pixels in the reference region. The imaging system applies the offset to each pixel in the set of pixels. The imaging system bins subsets of the set of pixels to generate a new image with lower resolution than the image received from the image sensor.

### Example Systems

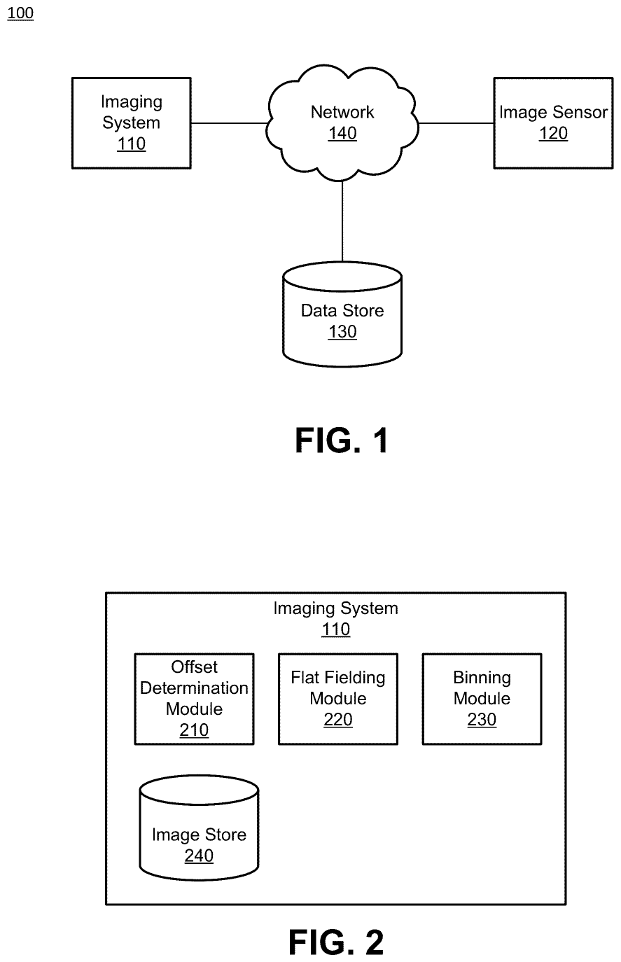

FIG. 1 illustrates one embodiment of a system environment 100 suitable for image processing. In the embodiment shown, the system environment 100 includes an imaging system 110, an image sensor 120, and a data store 130, all connected via a network 140. In other embodiments, the system environment 100 includes different or additional components. Furthermore, functionality may be distributed between components differently than described.

The image sensor 120 is a sensor that detects light in a field of view. For example, the image sensor 120 may be a charge-coupled device (CCD) or active-pixel sensor (CMOS sensor). The image sensor 120 comprises a set of pixels. The pixels of the image sensor 120 may be divided among two regions: an active region and a reference region. The active region is a region of the image sensor where pixels typically receive light during normal operation. The reference region or “dark region” is a region of the image sensor where pixels receive less than a threshold amount of light during normal operation. The reference region may be included in the image sensor 120 in the manufacturing process and may be physically covered to block light from entering the region.

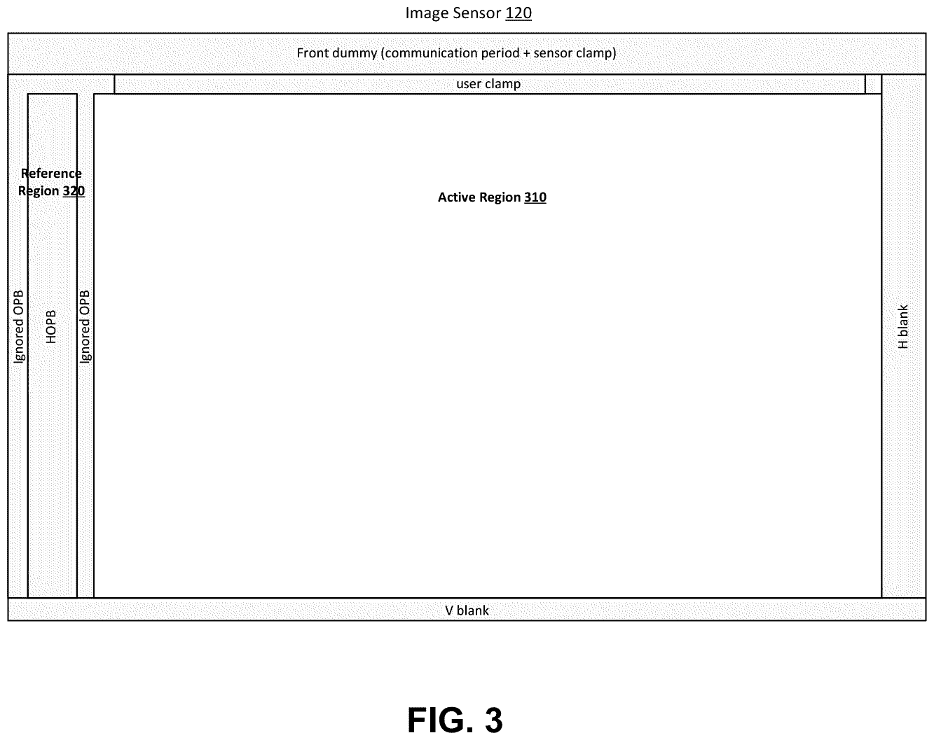

FIG. 3 illustrates an active region and reference region of an example image sensor 120, in accordance with one or more embodiments. The active region 310 includes pixels that receive light during normal operation of the image sensor 120. The active region 310 may additionally include pixels that are ignored or used for color processing. Such pixels are not shown in FIG. 3 but may be located at the edges of the active region 310. The reference region 320 includes pixels that receive little to no light during operation of the image sensor 120. In some image sensors, at least some of the pixels in the reference region 320 are designed to receive no light and are referred to as “optically black pixels.” The reference region 310 may include pixels that are ignored (e.g., ignored OPB).

The imaging system 110 is one or more computing devices that process image data generated by the image sensor 120 (such as applying flat-fielding and binning). The imaging system 110 may also control operation of the image sensor 120 (e.g., by providing control signals indicating when the image sensor 120 should capture an image and select settings to use for image capture). An example imaging system may use the image sensor 120 to capture images of biological samples, such as proteins in a blood or tissue sample produced as part of a Western blotting technique. Western blotting is a laboratory technique used to detect a specific protein in a blood or tissue sample. The method involves using gel electrophoresis to separate the sample's proteins. The biological samples produced as a part of a Western blotting technique may present chemiluminescence or fluorescence. Further details of various embodiments of the imaging system 110 are described with respect to FIG. 2.

The data store 130 includes one or more non-transitory computer-readable storage media that stores images captured by the image sensor 120. The imaging system 110 may access images from the data store 130 and process the images. The imaging system 110 may store processed images in the data store. Note that although the data store 130 is shown as an independent component, separate from the imaging system 110, in some embodiments, the data store 130 may be part of the imaging system 110.

FIG. 2 illustrates one embodiment of the imaging system 110. In the embodiment shown, the imaging system 110 includes an offset determination module 210, a flat-fielding module 220, a binning module 230, and an image store 240. In other embodiments, the imaging system 110 includes different or additional components. Furthermore, the functionality may be distributed between components differently than described.

The offset determination module 210 dynamically determines an offset for an image captured by the image sensor 120. The offset for the image sensor 120 represents a baseline value reported by the pixels of the image absent any signal (i.e., the “true zero” of the pixels). An offset of 100, for example, would indicate that the values of the pixels in images captured by the image sensor 120 are off by 100. That is, a pixel with a value of 100 represents a signal of zero, a pixel with a value 101 represents a signal of one, and so on. Different image sensors may have different offsets and the offset of any given image sensor may vary from image to image that it captures.

In some embodiments, the offset determination module 210 receives an offset value from the image sensor 120. For example, the image sensor 120 may report an offset of 100, indicating that the values of the pixels in images captured by the image sensor are relative to a baseline of 100. However, the image sensor 120 may not always report a consistent offset. For example, the image sensor 120 may report an offset of 100 for a first image but report an offset of 99 for a second image.

In some embodiments, the offset determination module 210 computes an offset for an image sensor using a reference region of the image sensor. Some image sensors, such as CMOS sensors, are manufactured to include a reference region where pixels in the frame receive little to no light. The offset determination module 210 identifies pixels in the reference region. The offset determination module 210 computes a reference region response by computing the average value of the identified pixels, the median value of the identified pixels, or by using another statistical method. For example, if the reference region included three pixels with values 99, 100, and 101, the offset determination module 210 would compute the reference region response as 100. The offset determination module 210 may use the reference region response as the offset for the image sensor.

In some embodiments, the offset determination module 210 may compute the offset based on the reference region response and an estimated amount of dark current. Dark current refers to an amount of current that flows through an image sensor when no light is hitting the sensor (i.e., the frame is dark). The relationship between the reference region response, the offset, and the dark current is shown by Equation 1:

$$Reference Region = Offset + Dark Current \qquad ( EQ . 1 )$$

For short exposures, the offset determination module 210 estimates that the amount of dark current is negligible. Thus, the offset determination module 210 simply computes the offset as the reference region response, without any further adjustments. For long exposures, the offset determination module 210 assumes that the amount of dark current is greater than zero. The offset determination module 210 may estimate the amount of dark current using a shot noise method. In a shot noise method, the offset determination module 210 measures the noise in an image and estimates the dark current that caused the noise. The offset determination module 210 computes the offset as the reference region response minus the dark current contribution.

In some embodiments, the dark current may be non-uniform across the reference region and the active region. The offset determination module 210 corrects this non-uniformity so a more accurate determination of the offset may be made. The offset determination module 210 corrects the non-uniformity using a baseline dark current value obtained during the manufacturing of the image sensor. In manufacturing, the image sensor 120 takes a first image with a long exposure (e.g., 15 minutes). The non-uniformity of the first image is measured, and the offset determination module 210 uses the measured non-uniformity of the first image as a baseline dark current value. Using the assumption that dark current follows a linear relationship with time, the offset determination module 210 computes the non-uniformity for a second image with an exposure time longer (or shorter) than the first image. The offset determination module 210 computes the non-uniformity for the second image by applying a linear transformation or mapping to the baseline dark current value.

In some embodiments, the offset determination module 210 identifies hot pixels in the reference region and ignores the values of the hot pixels in computation of the offset. Hot pixels are pixels with dark current values different from the dark current values of the other pixels in the reference region. The offset determination module 210 may identify hot pixels by comparing the value of each pixel to a threshold value. For example, the offset determination module 210 may compare the value of each pixel to the average value for all the pixels in the black reference and identify pixels that deviate a standard deviation from the average or from the pixel's nearest neighbors. The offset determination module 210 may ignore the values of hot pixels when computing the average or median value of pixels in the reference region.

The offset determination module 210 applies the offset to images captured by the image sensor 120. To apply the offset to an image, the offset determination module 210 subtracts the offset from the value of each pixel in the image. In some embodiments, the offset determination module 210 adjusts the offset such that, when applied, the values of each pixel remain positive (or zero).

The flat-fielding module 220 applies flat-field correction to an image captured by the image sensor 120. Flat-field correction, or “flat-fielding,” is an image processing technique used to correct pixel-to-pixel variations in an image that are caused by the image sensor or imaging system, rather than by the phenomenon being detected. Variations may be caused by scratches or artifacts on the lens of the image sensor 120 or by gains or dark currents in the image sensor 120. Variations may be caused by the shape of the lens itself. For example, imaging lens vignetting is a form of variation where the pixels at the edges of a field of view receive less light than pixels at the center of the field of view due to the shape of the lens. Imaging lens vignetting produces an effect where pixels at the edge of an image appear darker than pixels at the center of the image. Flat-fielding corrects for this variation. Flat-fielding may also correct for illumination non-uniformity or application-specific illumination, for example in applications involving fluorescence.

In some embodiments, the flat-fielding module 220 applies flat-field correction to an image using a flat-field image. A flat-field image is an image captured by the image sensor 120 that captures a uniformly-illuminated target. For example, a flat-field image may be of a blank plate, a plate covered in a uniformly fluorescent target, or a plate with features of known dimensions and luminescence, etc. As the flat-field image is an image of a uniformly illuminated target, any variations between the values of the pixels in the flat-field image are variations caused by the image sensor 120 (e.g., dust, scratches, vignetting). The flat-fielding module 220 subtracts the flat-field image from the image being corrected. That is, the flat-fielding module 220 subtracts the value of each pixel in the flat-field image from the value of a corresponding pixel in the image being corrected. Alternatively, the flat field values may be stored as ratios and the flat-fielding module 220 may multiply or divide the pixel values in the image being corrected by the corresponding flat-field values. It should be appreciated that other embodiments may represent the flat field in other ways and adjust pixel values of the image being corrected using any suitable mathematical combination of the image pixel values and the corresponding flat field values. In some embodiments, the flat-fielding module 220 applies flat-field correction to an image using a polynomial that is radially symmetric about the center of the image and characterizes lens roll-off as a function of radius (i.e., distance from the center of the image). The flat-fielding module 220 adjusts the value of each pixel in the image based on the output of the polynomial.

The flat-fielding module 220 may apply flat-field correction to an image that has been adjusted to account for the offset of the image sensor 120 (e.g., by the offset determination module 210). Applying flat-field correction to images adjusted for the offset can result in improved results because it reduces the amplification of offset errors by the flat-fielding operation. In other words, as many flat-fielding techniques involve scaling pixel values (e.g., multiplying pixel values by a flat fielding correction value), applying flat-fielding techniques to images adjusted for an offset reduces the effect that the offset and any errors in that offset have on the final image.

The binning module 230 applies binning to an image. Binning is a technique that combines multiple pixels in an image to improve signal to noise ratio at the expense of reducing the resolution of the image. For sensitive chemiluminescence and fluorescence detection, binning is often used to increase the system sensitivity. To perform binning on an image, the binning module 230 combines the values of a set of adjacent pixels into a value for one, larger pixel. The binning module 230 may average or sum the values of the pixels. For example, for a 16 by 16 array of pixels, the binning module 230 may sum the values of all 256 pixels to form a single pixel value. As a result of the binning, the signal to noise ratio of the combined pixel is an improvement over the signal to noise ratio of the single pixels by a factor of 256. However, binning also combines any offset errors included in the combined pixels. Therefore, without dynamic determination and accounting for the offset, the resulting combined offset errors may be significant. Conversely, the dynamic determination of offset for the image by the offset determination module 210 can significantly reduce the ratio of the combined offset error and the signal of interest.

The image store 240 is one or more computer-readable media that store local copies of images captured by the image sensor 120. The local copies are processed by the imaging system 110. The imaging system 110 may save the processed images in the data store 130. Local storage of images may improve the efficiency and processing speed of the imaging system 110 where cloud-based storage (e.g., data store 130) is used for long-term storage of data.

### Exemplary Image Processing

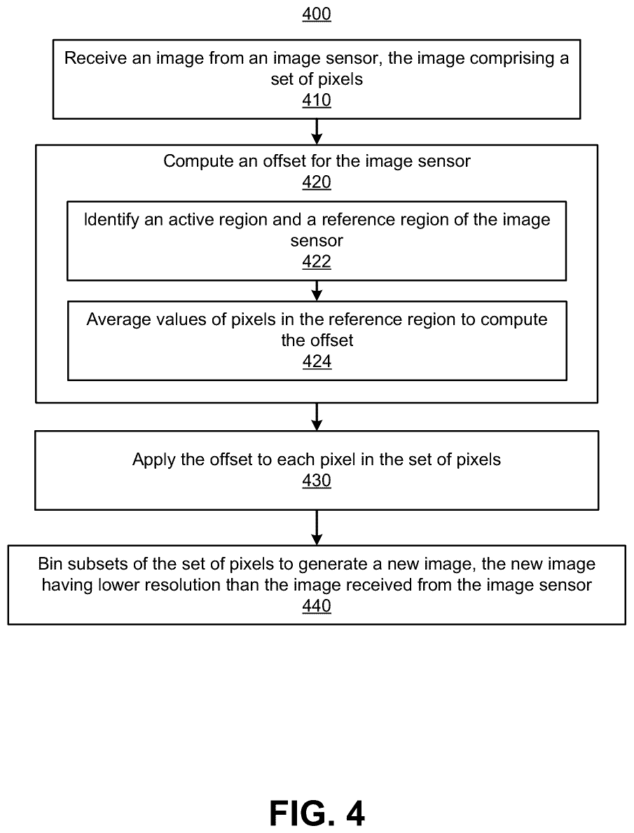

FIG. 4 is a flowchart of a method for processing an image using flat-fielding and binning techniques, in accordance with an embodiment. The process shown in FIG. 4 may be performed by one or more components of an image processing system/service (e.g., the imaging system 110). Other entities may perform some or all of the steps in FIG. 4. Embodiments may include different or additional steps, or perform the steps in different orders.

In the embodiment shown, the process 400 begins with the imaging system 110 receiving 410 an image from an image sensor. The image includes a set of pixels. The image sensor may be a CMOS sensor.

The imaging system 110 computes 420 an offset for the image. The offset for the image represents a baseline value for the response of the image sensor 120 in the absence of signal. To compute 420 the offset for the image sensor, the imaging system 110 identifies 422 an active region and a reference region of the image sensor. The active region is a region of the image sensor where pixels typically receive light during normal operation. The reference region or “dark region” is a region of the image sensor where pixels receive less than a threshold amount of light during normal operation. The imaging system averages 424 values of pixels in the reference region to compute the offset.

The imaging system 110 applies 430 the offset to each pixel in the set of pixels. The imaging system 110 may, for each pixel, subtract the offset from the value of the pixel, add the offset to the value of the pixel, divide the value of the pixel by the offset, multiply the value of the pixel by the offset, or use any other appropriate mathematical combination of the pixel value and offset, depending on how the offset is calculated and represented.

The imaging system 110 bins 440 subsets of the set of pixels to generate a new version of the image at a lower resolution. The imaging system 110 bins the subsets by combining the values of the pixels in the subset into one value. The imaging system 110 may average or sum the values of the pixels. The new version of the image may then be analyzed to identify signals of interest

### Exemplary General Computing System

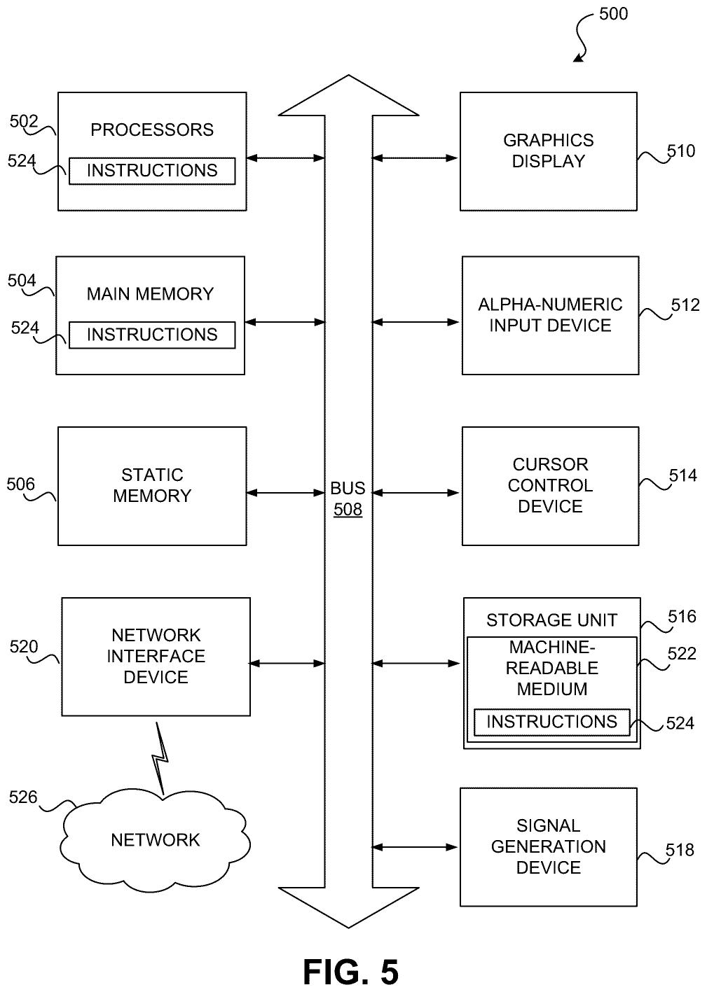

FIG. 5 illustrates an example general computing system, according to one or more embodiments. Although FIG. 5 depicts a high-level block diagram illustrating physical components of a computer used as part or all of one or more entities described herein, in accordance with an embodiment, a computer may have additional, less, or variations of the components provided in FIG. 5. Although FIG. 5 depicts a computer 500, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 5 are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O hub 522. In another embodiment, the memory 506 is coupled directly to the processor 502 instead of the chipset 504. In some embodiments, the computer 500 includes one or more communication buses for interconnecting these components. The one or more communication buses optionally include circuitry (sometimes called a chipset) that interconnects and controls communications between system components.

The storage device 508 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 508 can also be referred to as persistent memory. The pointing device 514 may be a mouse, track ball, or other type of pointing device, and is used in combination with the keyboard 510 to input data into the computer 500. The graphics adapter 512 displays images and other information on the display 518. The network adapter 516 couples the computer 500 to a local or wide area network.

The memory 506 holds instructions and data used by the processor 502. The memory 506 can be non-persistent memory, examples of which include high-speed random access memory, such as DRAM, SRAM, DDR RAM, ROM, EEPROM, flash memory.

As is known in the art, a computer 500 can have different or other components than those shown in FIG. 5. In addition, the computer 500 can lack certain illustrated components. In one embodiment, a computer 500 acting as a server may lack a keyboard 510, pointing device 514, graphics adapter 512, or display 518. Moreover, the storage device 508 can be local or remote from the computer 500 (such as embodied within a storage area network (SAN)).

As is known in the art, the computer 500 is adapted to execute computer program modules for providing functionality described herein. As used herein, the term “module” refers to computer program logic utilized to provide the specified functionality. Thus, a module can be implemented in hardware, firmware, or software. In one embodiment, program modules are stored on the storage device 508, loaded into the memory 506, and executed by the processor 502.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for verifying an account with an on-line service provider corresponds to a genuine business. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

What is claimed is:

1. A method comprising:
receiving an image from an image sensor, the image comprising a set of pixels;
dynamically computing an offset for the image by:
identifying an active region and a reference region of the image sensor, and
averaging values of pixels in the reference region to compute the offset,
applying the offset to each pixel in the set of pixels; and
binning subsets of the set of pixels to generate an updated image, the updated image having lower resolution than the image received from the image sensor.

2. The method of claim 1, wherein computing the offset for the image comprises computing an offset based on an amount of dark current.

3. The method of claim 2, wherein the amount of dark current is non-uniform across the reference region and the active region.

4. The method of claim 2, further comprising estimating the amount of dark current based on an image taken with long exposure.

5. The method of claim 2, wherein computing an offset for the image sensor further comprises:
identifying hot pixels in the reference region; and
ignoring values of the hot pixels in computation of the offset.

6. The method of claim 1, wherein applying the offset to each pixel in the set of pixels comprises, for each pixel, subtracting the offset from a value of the pixel.

7. The method of claim 1, further comprising applying a flat-field correction technique to each pixel in the set of pixels.

8. The method of claim 1, wherein binning subsets of the set of pixels to generate the updated image comprises computing average pixel values of the subsets.

9. The method of claim 1, wherein the image sensor is a CMOS sensor.

10. The method of claim 1, wherein the image is a Western Blot image.

11. A non-transitory computer-readable medium configured to store instructions, the instructions when executed by a processor cause the processor to:
receive an image from an image sensor, the image comprising a set of pixels;
dynamically compute an offset for the image by:
identifying an active region and a reference region of the image sensor, and
averaging values of pixels in the reference region to compute the offset,
apply the offset to each pixel in the set of pixels; and
bin subsets of the set of pixels to generate an updated image, the updated image having lower resolution than the image received from the image sensor.

12. The non-transitory computer-readable medium of claim 11, wherein the instruction that when executed causes the processor to compute the offset for the image further comprises instructions to compute an offset based on an amount of dark current.

13. The non-transitory computer-readable medium of claim 12, wherein the amount of dark current is non-uniform across the reference region and the active region.

14. The non-transitory computer-readable medium of claim 12, wherein the instructions further comprise instructions that when executed cause the processor to estimate the amount of dark current based on an image taken with long exposure.

15. The non-transitory computer-readable medium of claim 12, wherein the instruction that when executed causes the processor to compute an offset for the image sensor further comprises instructions to:
identify hot pixels in the reference region; and
ignore values of the hot pixels in computation of the offset.

16. The non-transitory computer-readable medium of claim 11, wherein the instruction that when executed causes the processor to apply the offset to each pixel in the set of pixels comprises instructions to, for each pixel, subtract the offset from a value of the pixel.

17. The non-transitory computer-readable medium of claim 11, wherein the instructions further comprise instructions that when executed cause the processor to apply a flat-field correction technique to each pixel in the set of pixels.

18. The non-transitory computer-readable medium of claim 11, wherein the instruction that when executed causes the processor to bin subsets of the set of pixels to generate the updated image comprises instructions to compute average pixel values of the subsets.

19. The non-transitory computer-readable medium of claim 11, wherein the image sensor is a CMOS sensor.

20. A system comprising:
an image sensor; and
an image processing system configured to:
receive an image from the image sensor, the image comprising a set of pixels;
dynamically compute an offset for the image by:
identifying an active region and a reference region of the image sensor, and
averaging values of pixels in the reference region to compute the offset,
apply the offset to each pixel in the set of pixels; and
bin subsets of the set of pixels to generate an updated image, the updated image having lower resolution than the image received from the image sensor.
